(19) United States
(12) Patent Application Publication
(10) Pub. No.: US 2015/0002950 A1
(43) Pub. Date: Jan. 1, 2015

(54) REMOVABLE LENSES FOR MOBILE ELECTRONIC DEVICES

(71) Applicant: olloclip, LLC, Huntington Beach, CA (US)

(72) Inventors: Patrick D. O'Neill, Huntington Beach, CA (US); Chong Pak, Lakewood, CA (US); Ryan Nguyen, Fountain Valley, CA (US); Jason Patrick, Long Beach, CA (US); Bobby Kong, Walnut Park, CA (US); Daniel Arato, Los Angeles, CA (US)

(73) Assignee: olloclip, LLC, Huntington Beach, CA (US)

(21) Appl. No.: 14/213,899

(22) Filed: Mar. 14, 2014

Related U.S. Application Data
(60) Provisional application No. 61/800,344, filed on Mar. 15, 2013.

(51) Int. Cl. G02B 7/02; H04N 5/225; G03B 17/56

(52) U.S. Cl. CPC G02B 7/02; G03B 17/565; H04N 5/2254
USPC 359/827

(57) ABSTRACT

A lens component configured to be removably attachable to a protective case or mounting component. The protective case or mounting component configured to be removably attachable to a communication or mobile electronic device. The protective case or mounting component includes one or more locking members movable between a first open position and a second closed position. The one or more locking members configured to engage with one or more engagement members of the lens component. The engagement of the one or more locking member with the one or more engagement members securing the lens component in place.

### CROSS-REFERENCE TO RELATED APPLICATIONS

This application claims the benefit of U.S. Provisional Application No. 61/800,344, filed Mar. 15, 2013, the entirety of which is incorporated herein by reference.

### BACKGROUND OF THE INVENTIONS

1. Field of the Inventions

This invention relates generally to accessories for communication or mobile electronic devices (e.g., mobile telephones, mobile texting devices, mobile information storage and display devices, electronic pad devices, laptop computers, desktop computers, etc.), and specifically to removable functional components for communication or mobile electronic devices.

2. Description of the Related Art

In recent years, many advances in computer networking and processing technology have made it possible for communication devices to include cameras that permit users to capture images. In many cases, these images can be stored, processed, and transmitted. However, there are many design constraints on onboard camera in mobile electronic devices that can limit the weight, size, expense, shape, adjustability, and overall quality of the lensing systems of such cameras. Consequently, many cameras in communications devices are inadequate for a wide variety of photographic needs and may produce poor quality photographic images.

The deficiencies of onboard camera lenses can be addressed by modular or detachable lensing systems. Such lensing systems may be mounted or attached to communication devices such that one or more auxiliary lenses are positioned substantially over the onboard camera lenses of the communication devices. The auxiliary lenses can enhance or alter the light that may be captured by the onboard cameras to generate an image.

Other accessories may be used with communication devices, such as protective cases. A case is intended to provide protection for the communication device, and inhibit wear and/or damage to the communication device. Conventionally, protective cases cover the exterior of the communication device, or some portion thereof, to cushion impacts, protect against scratches, and the like.

### SUMMARY

Certain embodiments can include any one, or any combination, of any of the following: a mounting component provided for mounting a removable lens component and configured to be removably attachable to a mobile electronic device, the mounting component including an aperture configured to generally expose an on-board lens of a mobile electronic device when the mounting component is installed on the mobile electronic device, wherein the aperture is configured to receive a removable lens component. The mounting component can include an engagement member configured to engage with a corresponding engagement structure of the removable lens component to secure the removable lens component in position on the mobile electronic device. At least one of the engagement member and engagement structure can be configured to be movable between a first or engaged position and a second or released position. In some embodiments, in the first position the engagement member and engagement structure are configured to be in engagement with one another and in the second position, the engagement member and engagement structure are space apart relative to one another.

In some embodiments, the mounting component includes or is part of a protective case for a mobile electronic device. In some embodiments, the engagement member is slidable within the aperture between the first position and the second position.

In some embodiments, the engagement member comprises a curved surface forming an inner locking ring with a curved engagement member of the protective case in the first position, wherein the inner locking ring is configured to receive an outer locking ring of the engagement structure of a removable lens component in the first position.

In some embodiments, the curved surface of the inner locking ring is biased towards the second position and exerts an outward force on an inner surface of the outer locking ring of the engagement structure of a removable lens component to secure the removable lens component in position on the mobile electronic device when the outer locking ring is received by the inner locking ring.

In some embodiments, the mounting component includes at least one of a body member configured to be attachable to a first corner of a mobile electronic device and a protective case for a mobile electronic device.

In some embodiments, the engagement member includes a recess configured to receive the engagement structure of a removable lens component in the first position to secure a removable lens component in position on the mobile electronic device.

In some embodiments, a removable lens component includes an actuator, such as an actuatable handle and/or switch and/or dial for moving the engagement structure between the first position and the second position.

In some embodiments, the mounting component includes an insert configured to be installed in the aperture. In some embodiments, the insert is configured to receive a removable lens component within an aperture formed on the insert.

In some embodiments, first and second inserts can be installed in or near the aperture, wherein the first insert is configured to mount a removable lens component at a first angle relative to the mobile electronic device and the second insert is configured to mount a removable lens component at a second angle relative to the mobile electronic device, the first angle different from the second angle.

In some embodiments, a removable lens component received in the insert is rotatable within the aperture of the insert such that a first engagement structure of the removable lens component is positioned under an edge portion of the insert.

In some embodiments, the engagement member is slidable between the first position for engaging with a second engagement structure of a removable lens component to prevent rotation of the removable lens component and the second position for disengaging from the second engagement structure of the removable lens component to allow rotation of the removable lens component within the insert.

In some embodiments, the insert includes a first and second layer, the first layer configured to be engaged with an inner surface of the protective case and the second layer configured to be generally flush with an outer surface of the protective case when the insert is installed, such as near and/or within the aperture.

Certain embodiments can include any one, or any combination, of any of the following: a removable lens component configured to be removably attachable to a mobile electronic device, the removable lens component including a first aperture configured to be in optical communication with an on-board lens of a mobile electronic device when the removable lens component is installed on the mobile electronic device. The removable lens component can include an engagement member configured to engage with a corresponding engagement structure of at least one of a protective case and a mounting component installed on the mobile electronic device to secure the removable lens component in position on the mobile electronic device. At least one of the engagement member and engagement structure can be movable between a first or engaged position and a second or released position. In the first position, the engagement member and engagement structure can be configured to be in engagement with one another; and in the second position, the engagement member and engagement structure can be space apart relative to one another.

In some embodiments, the engagement member is coupled to an actuator such that moving the actuator between the first and second positions, moves the engagement member in and out of engagement with the engagement structure.

In some embodiments, the actuator includes one of a handle, a lever, a switch, and/or a dial movable by a user. In some embodiments, the removable lens component is configured to be positioned within a second aperture of an insert on the protective case and is rotatable within the second aperture such the engagement member is positionable under a surface of the insert.

In some embodiments, the removable lens includes a second engagement member configured to receive an engagement structure of the protective case in the first position such that the removable lens is prevented from rotating within the second aperture.

In some embodiments, the engagement member includes an outer locking ring configured to be received by an inner ring formed by first and second engagement structures of the protective case.

### BRIEF DESCRIPTION OF THE DRAWINGS

Certain embodiments of the inventions will now be discussed in detail with reference to the following figures. These figures are provided for illustrative purposes only, and the inventions are not limited to the subject matter illustrated in the figures. For example, the labels and descriptions in text in the drawings are examples only and should not be understood to limit the usage, materials, function, applicability, or any other aspect of the inventions disclosed herein; rather, such labels and descriptions should be viewed as disclosing some examples or embodiments of a broader genus of structures and features that may or may not include the specific attributes set forth in text in the drawings. Throughout the drawings, reference numbers may be re-used to indicate correspondence between referenced elements.

FIGS. 1A-1C illustrate a removable lens, for use with a mobile electronic device, that may be mounted to a protective case, and/or a removable mounting clip, etc.

FIGS. 1D-1E illustrate a removable lens, for use with a mobile electronic device that may be mounted to a protective case, and/or removable mounting clip, etc.

FIGS. 2A-2G illustrate a rear view of a protective case, for a mobile electronic device, that provides a mount for a removable lens.

FIGS. 3A-3C illustrate a front view of the protective case of FIGS. 2A-2G.

FIGS. 4A-4C illustrate a protective case, for a mobile electronic device, that provides a mount for a removable lens that in some embodiments may be configured to tilt the removable lens.

FIGS. 4D-4E illustrate the mount of FIGS. 4A-4C for a removable lens that in some embodiments may be configured to tilt the removable lens.

### DETAILED DESCRIPTION OF EXAMPLES

The present disclosure relates generally to protective cases, removably attachable lenses and mounting clips, and other accessories for communication devices. Many different structures, features, steps, and processes are shown and/or described in discrete embodiments for convenience, but any structure, feature, step, or process disclosed herein in one embodiment can be used separately or combined with or used instead of any other structure, feature, step, or disclosed in any other embodiment. Also, no structure, feature, step, or processes disclosed herein is essential or indispensable; any may be omitted in some embodiments.

The terms “protective cases” or “cases” as referred to herein, describe cases that are different from, separate from, removably attachable, and/or in addition to the shells, cases, or exterior housings that communication devices are packaged in (e.g., that form a part of the actual device) when originally constructed, sold, and/or produced by the manufacturer. Protective cases can cover the exterior of communication or mobile electronic devices (e.g., mobile phones, media players, portable gaming systems, etc.) or some portion thereof to cushion impacts, protect against scratches, add grip, change the aesthetics (e.g., allow a user to decorate portions of the device with different colors, jewelry, materials, shapes, text, backgrounds, graphics, etc.) and the like. Protective cases can include access regions, including exposed regions, moveable access regions, external actuators, cutaways, or openings for accessing features and components of the communication device on which the cases are installed, such as one or more onboard cameras, screens, buttons, electrical connectors, lenses, jacks, inputs, usb connections, vents, speakers, memory cards, finger-print readers, microphones, optical elements, etc. However, it can be difficult to attach an accessory or some other auxiliary structure to a communication or mobile electronic device when the device is generally surrounded by the protective case. For example, the protective case may not permit direct access to the communication or mobile electronic device or the auxiliary structure may be specially sized for attachment to a communication device with a housing of a particular shape and size. As a result, the auxiliary structure may not fit appropriately on the communication device when the communication device is covered by the protective case. In addition, some protective cases may not provide all of the features desired by a user. Some examples of removable or modular accessories for mobile electronic devices (including the Olloclip® lens accessory) that can be used with the embodiments disclosed herein are illustrated and described in U.S. Pat. No. 8,279,544, which is titled “Selectively Attachable and Removable Lenses for Communication Devices” and which issued on Oct. 2, 2012, the contents of which are hereby incorporated by reference in their entirety.

Some aspects of this disclosure relate to protective cases and removable lenses or other modular accessories for use with a communication or mobile electronic device. The protective cases or other mounting mechanisms can provide mounting structures and mechanisms that facilitate the attachment of removable lenses or other accessories. For example, an auxiliary optical region or an auxiliary optical region or an auxiliary lensing component may be used with a mobile electronic device to alter or enhance light or images that are captured by an onboard camera lens of a mobile electronic device. The protective cases or other mounting mechanisms can expose areas or components of a communication device such that an accessory may be used with the communication device. For example, an auxiliary lensing component may be used with a communication device when an onboard camera lens, or some portion of the device that includes the camera, is exposed by the protective case.

The terms “lensing component” or “lens” or any derivatives thereof and related terms are used in accordance with their customary meanings and include any optical structure that alters or modifies one or more characteristics of light (including but not limited to magnification, attenuation, darkening, polarization, filtering, reflection, glare, color, image field, and/or image shape, etc.). Lens components or devices can be removably attached to mobile electronic devices to selectively enhance or otherwise change an image created from light that is transmitted through a lens to an onboard camera lens of the mobile electronic devices. For example, lens components such as those disclosed in U.S. Pat. No. 8,279,544 may be secured to a mobile electronic device by a clip or other mounting mechanism that contacts generally opposing sides of the mobile electronic device. The lens component may include a different lens on each side of the clip portion (e.g., one side may have a fisheye lens, while the generally opposing side may have a wide angle, macro, telephoto, or some other photographic lens). When a user wishes to use a different lens, the user may rotate the lens component so that the lens from other side of the clip portion is positioned to alter light passing through to the onboard camera lens of the mobile electronic device.

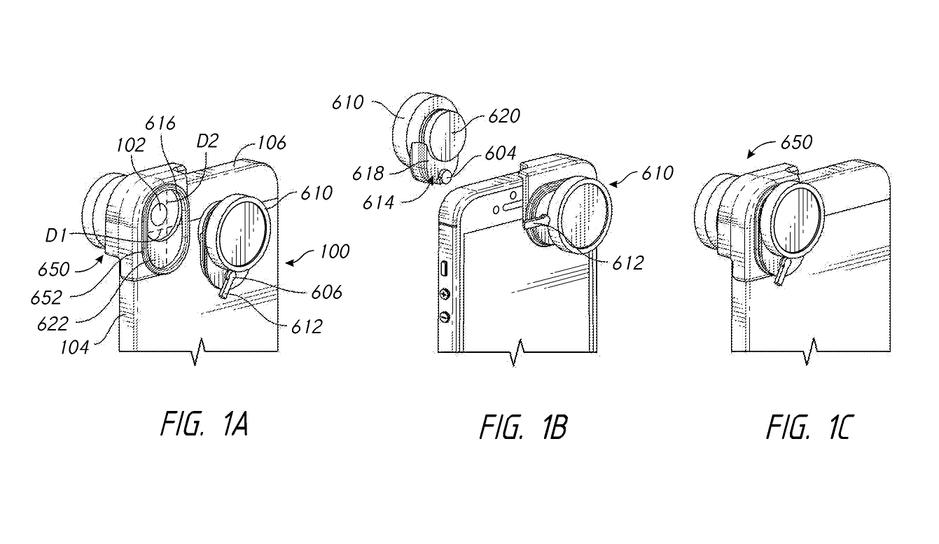

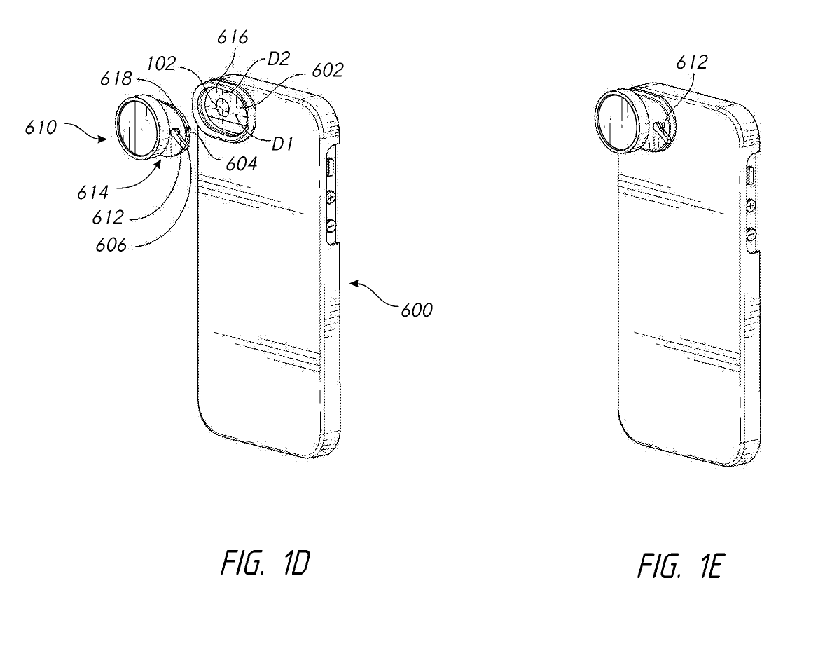

FIGS. 1-4 illustrate various mounting mechanisms and methods. One or more of the mounting mechanisms and methods illustrated in FIGS. 1-4 may be used with, on, or in one or more protective cases, mounting clips and/or other mounting accessories, structures, or mechanisms that may be installed on a communication or mobile electronic device as described herein, and/or one or more of the mounting mechanisms may be integrated into a communication or mobile electronic device itself.

FIGS. 1D-1E illustrate a protective case 600 for use with a communication or mobile electronic device 100. The mobile electronic device 100 illustrated in FIGS. 1A-1E is an iPhone 5, sold by Apple, Inc. of Cupertino, California. The protective case 600, and other cases, mounting clips, structures, and/or accessories disclosed herein, may be configured for use with other communication or mobile electronic devices. The mobile electronic device 100 includes an onboard camera lens 102 that may be used to capture light for photography, video recording, etc. The protective case 600 and/or other mounting component may include an opening or cut-out portion (e.g., aperture 616) that generally exposes the onboard camera lens 102. In some embodiments, the aperture 616 can extend about or around the complete or entire perimeter of a recess 602 of the protective case 600 or other mounting component 650 for attachment of a lens component 610 or other accessory as discussed below as illustrated in FIG. 1D. In some embodiments, the aperture 616 extends about or around only a portion of the perimeter of the recess 652 of the protective case 600 or other mounting component 650 for attachment of a lens component 610 or other accessory as illustrated in FIG. 1A.

FIGS. 1A-1E illustrate a removably attachable lens component 610 (e.g., for use with the onboard camera lens 102 of the mobile electronic device 100) or other accessory that may be mounted to the protective case 600, and/or to a removable mounting component 650 (e.g., clip, mount). The protective case 600 and/or removable mounting component 650 are configured to be installed on the mobile electronic device 100 and releasably retain the removably attachable lens component 610 or other accessory.

In some embodiments, as illustrated in FIGS. 1A-1E, the onboard camera lens 102 is positioned near a first corner of the mobile device where first 104 and second 106 generally orthogonal sides generally converge. The first and second sides 104 and 106 can be located on generally opposing sides of the mobile electronic device 100 from a second corner or from third and fourth generally orthogonal sides, thereby positioning the input or output devices of the mobile electronic device (e.g., onboard lens, flash, microphone) a substantial distance away from the third and fourth generally orthogonal sides. In some embodiments, the onboard lens is located in another place on the mobile electronic device, such as in a generally upper central region, with the corresponding mounting structures, attachment structures, cases, and/or clips, etc., configured to be positioned accordingly.

The mounting component 650 can be permanently or removably attached to the mobile electronic device 100 using any or all of the features, structures, and/or steps illustrated or described in U.S. Pat. No. 8,279,544. For example, the mounting component 650 may be configured to clip onto a corner (e.g., first) of the mobile electronic device 100, such that mounting component contacts generally orthogonal sides 104, 106 of the mobile electronic device 100. The mounting component 650 can be configured to receive the lens component 610 for altering or enhancing images taken by the onboard camera lens 102 of the mobile electronic device 100. In some embodiments, a protective case 600 may be used instead of the mounting component 650. The protective case 600 may also be configured to receive the lens component 610.

In some embodiments, the same lens component 610 is configured to be received in both the mounting component 650 and the protective case 600. In some embodiments, a lens component 610 is configured to be received in the mounting component 650 and is not configured to be received in the protective case 600. In some embodiments, a lens component 610 is configured to be received in the protective case 600 and is not configured to be received in the mounting component 650.

The lens component 610 may be coupled to the mounting component 650 or protective case 600 by being inserted into a corresponding recess 652 of the mounting component 650 or recess 602 of the protective case 600. While the recesses 652 or 602 and apertures 616 are illustrated as circular or oval in shape, the recesses 652 or 602 can comprise other shapes, such as generally: elliptical, diamond, semi-circular, angular, square, rectangle, trapezoidal, triangular, and/or polygonal, etc. Similarly, the lens component 610 can include a mounting base or portion 614 having a corresponding shape, size, configuration, orientation and/or outer perimeter as the recesses 652 or 602 and/or apertures 616 they are configured to be received in.

As illustrated with respect to the embodiment of FIGS. 1D-1E, the aperture 616 can extend about the entire recess 602 of the protective case 600. The mounting surface 618 of the mounting base or portion 614 can be relatively planar, level or flat to contact the relatively flat or level surface of the mobile electronic device 100 exposed by the aperture 616 and recess 602. However, in some embodiments, as illustrated with respect to the embodiment of FIGS. 1A-1C, the aperture 616 extends only about a portion of the inner perimeter of the mounting component 650. In such embodiments, the mounting base or portion 614 of the lens component 610 can include two mounting surfaces 618 and 620. The recess 652 of the mounting component 650 can include a stepped configuration having a raised surface 622 adjacent to the outer perimeter of the aperture 616 that exposes the lens 102 and back or front surface of the mobile electronic device 100. The mounting surface 620 extends past the surface of the mounting surface 618 in a direction parallel to an axis extending from the front surface to the back surface of the mobile electronic device. Such configurations facilitate contact between the back or front surface of the mobile electronic device 100 and the mounting surface 620 and the raised surface 622 and the mounting surface 618 when the lens component 610 is installed. The lens component 610 and the apertures 616 and recess 652 or 602 of the mounting component 650 and protective case 600 can include any of the configurations described herein.

In some embodiments, at least one of the inner perimeter of the recess 602 or 652 and the outer perimeter of the mounting portion 614 can include a gasket or rubber material to form a seal with the corresponding recess or mounting portion to aid retention of the lens component 610 on the mounting component 650 or protective case 600.

The lens component 610 may include a locking mechanism 612 for releasably, selectively, and/or removably coupling, retaining or securing the lens component 610 to or within the recesses 652 or 602 of the mounting component 650 and/or protective case 600. In some embodiments, the locking mechanism 612 is movable between a first position and a second position. In the first position (e.g., engaged, closed, locking position), the locking mechanism 612 is configured to lock, fix, or secure the lens component 610 into place or position to or within the recesses 652 or 602 of the mounting component 650 and/or protective case 600. In the second position (e.g., disengaged, open, unlocked position), the locking mechanism 612 is configured to unlock or unsecure the lens component 610, such that it can be installed, inserted, removed or uninstalled from the recesses 652 or 602 of the mounting component 650 and/or protective case 600.

In some embodiments, the locking mechanism 612 may include an actuator 606, such as a user-activated or actuable lever, switch, button, latch, or handle that extends from a side of the lens component 610 opposite the mounting component 650 and/or protective case 600, or which is otherwise accessible to a user. When a user wishes to lock, fix, maintain or secure the lens component 610 into place or position, the use may activate the actuator 606 (e.g., by rotating clockwise or otherwise moving a lever, switch, button, dial, latch, and/or handle). This may cause one or more retaining members, clips, protrusions or tabs 604 that are movably coupled or connected to the actuator 606 to be re-oriented, extended, moved, or shifted such that the one or more retaining members are engaged to, received or receivable by one or more corresponding locking recesses, members, holes, apertures or structures (not shown) in or near the recess 652 or 602 of the mounting component 650 or protective case 600. In the locking position, the potential for accidental or unintentional removal of the lens component 610 may be substantially lowered, decreased, minimized or eliminated. The user may then rotate or otherwise move the actuator 606 in an opposite direction (e.g., counterclockwise) to move the locking mechanism 612 to the unlocked position and cause the one or more retaining members, clips, protrusions or tabs 604 that are movably coupled or connected to the actuator 606 to be re-oriented, retracted, moved, or shifted such that the retaining members 604 are disengaged, removed or retracted from the one or more corresponding locking recesses, members, holes, apertures or structures (not shown) in or near the recess 652 or 602 of the mounting component 650 and/or protective case 600 allowing the user to install, insert, remove or uninstall the lens component 610.

In some embodiments, the locking mechanism 612 includes one or more actuators 606, with each actuator 606 movably coupled or connected to one corresponding retaining member 604. In other embodiments, the one or more actuators 606 are movably coupled or connected to more than one corresponding retaining members 604 (e.g., 2, 3, 4, 5, 6, etc.). In such an embodiment, a user can activate one actuator 606 to move several retaining members 604 for being received by corresponding locking members or structures positioned along multiple positions around or within the inner perimeter or interior edge of the recesses 652 or 602. This provides multiple engagement or locking positions around or within the perimeter of the recesses 652 or 602 that can further lower, decrease, minimize, or eliminate the potential for accidental or unintentional removal of the lens component 610 and/or increase the force of engagement between the lens component 610 and the protective case 600 and/or mounting component 650 when the locking mechanism 612 is in the locked position.

In some embodiments, as illustrated in FIGS. 1A-1C, the mounting component 650 includes two recesses 652 positioned on opposing surfaces or faces (e.g., front face and back face or anterior and posterior surfaces) of the mobile electronic device 100 when the mounting component 650 is installed. In such embodiments, the mounting component 650 receives or is configured to receive two lens components 610, one in each recess 652. This can be advantageous because certain mobile electronic devices 100 include two camera lenses (e.g., front facing and rear facing on opposite faces of the electronic device) so a user can attach or secure two lens components 610 simultaneously and/or on both faces of the mobile electronic device. In some embodiments, the lens components 610 positioned on each face are equivalent or the same. In some embodiments, it can be advantageous to secure or position lens components 610 or optical components of different capabilities (such as those disclosed elsewhere in this specification), providing to the user the convenience of using or having the capability to use two different lens components 610 without having to fully remove and switch one for the other. In some embodiments, it can be more convenient to secure two lens components to the protective case and/or mounting component even if the mobile electronic devices has only one camera lens and/or only one of the recesses is positioned around one of the lenses. This allows the user to easily carry at least two lens components on the mobile electronic device at the same time and have easier access to both when needed (e.g., when traveling, etc).

In some embodiments, the protective case 600 and/or mounting component 650 includes one recess 602 or 652 on a front face of the mobile electronic device 100 when installed on the device. In some embodiments, the protective case 600 and/or mounting component 650 includes one recess 602 or 652 on a rear face of the mobile electronic device 100 when installed on the device. In some embodiments, the protective case 600 and/or mounting component 650 includes two recesses 602 or 652 one on each face of the mobile electronic device 100 when installed on the device.

The protective case 600 and/or mounting component 650 can also include recesses 602 or 652 that are oriented when the protective case 600 and/or mounting component 650 are installed such that the two recesses 602 or 652 mirror one another but on different faces of the mobile electronic device 100. For example, as illustrated in FIGS. 1D-1E, the recess 602 on the back or posterior face of the mobile electronic device 100 includes an oval shape having a diameter or length D1 in a direction extending in a direction parallel to side 106 that is greater than a diameter or length D2 of the recess 602 extending in a direction parallel to side 104 when the protective case is installed. The second recess 602 on the front or posterior face of the mobile electronic device 100 when the protective case is installed can have the same structure (e.g., mirrored configuration). However, in some embodiments, the second recess 602 can have a different configuration (e.g., D2 greater than D1).

For example, with reference to FIGS. 1A-1C, the recesses 602 or 652 on the two opposing or opposite faces of the mobile electronic device 100 can be oriented or formed on the protective case 600 and/or mounting component 650 in a different manner or non-mirroring orientation (e.g., to avoid interfering with buttons, to cover less of the screen, or to expose other structures on the mobile device 100 at different positions on each face). For example, in some embodiments, recess 652 of FIG. 1A on the posterior or back face of the mobile device 100 when the mounting component 650 is installed, has a diameter or length of D1 less than length or diameter D2. As illustrated in FIG. 1B on the front or anterior face of the mobile device 100 when the mounting component 650 is installed, the recess 652 has a diameter or length of D1 greater than length or diameter D2. In such a configuration, the recess 652 or lens component 610 when installed can extend over the screen less in a direction generally parallel to side 104 than if D2 were greater than D1. Therefore, in some embodiments, the recesses on each face of the mobile electronic device 100 when the mounting component and/or protective case are installed can have mirrored configurations. In some embodiments, the recesses on each face of the mobile electronic device 100 when the mounting component and/or protective case are installed can have different or non-mirrored configurations. Additionally, the recesses 652 or 602 can be configured with length or diameter D2 greater than and/or less than length or diameter D1.

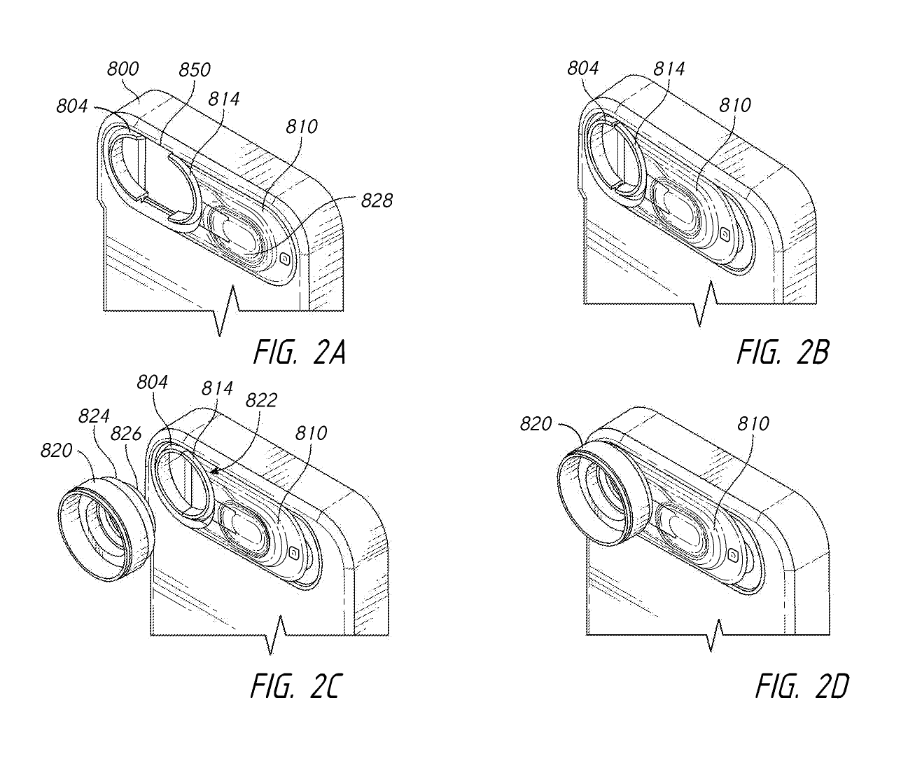

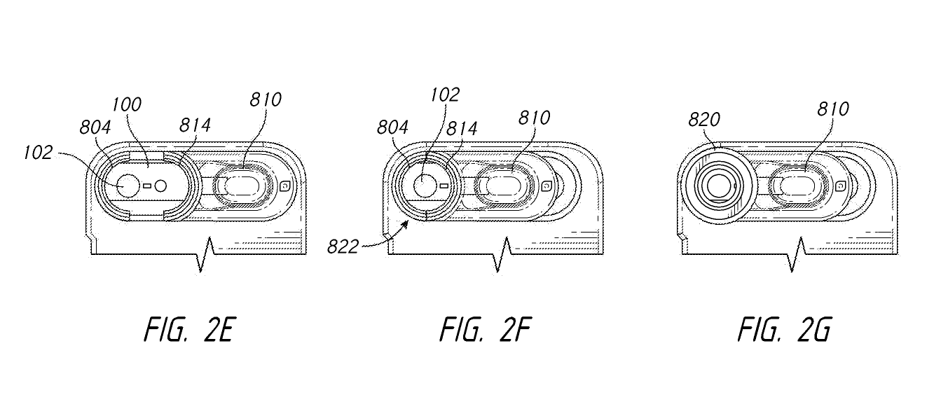

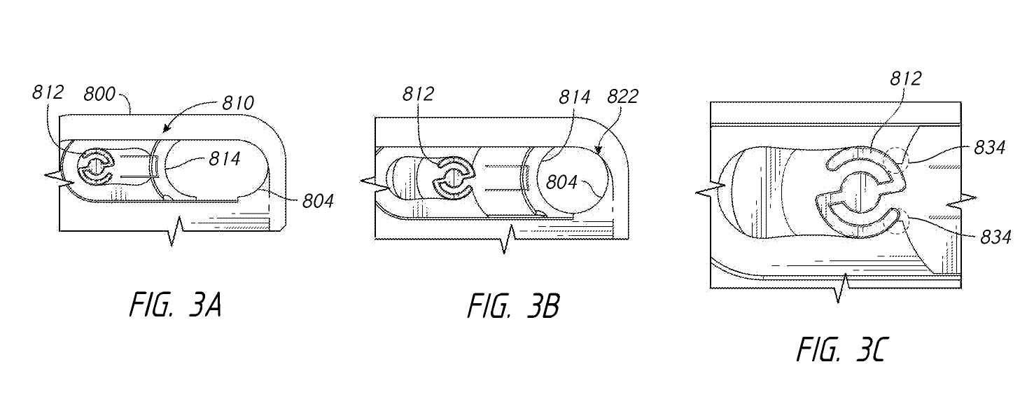

FIGS. 2A-3C illustrate a protective case 800 that includes a locking mount, mechanism, or member 810 to facilitate the mounting (e.g., securing, installing, engagement, positioning, or disengagement, uninstalling) of a removable lens component 820 to the protective case 800. As described above with respect to other lens components, the lens component 820 can alter or focus light passing from an area generally in front of the lens component 820 to an onboard camera lens of a mobile electronic device 100 onto which the protective case 800 is installed. Although the embodiments discussed below relate to the protective case 800, a mounting component (e.g., clip) can also include or be configured with the locking member 810 as described herein.

The protective case 800 and/or other mounting component may include an opening or cut-out portion, recess, or aperture 850 that generally exposes the onboard camera lens when the protective case 800 is installed on the mobile electronic device 100. The locking member 810 may be positioned generally within and movable through or within the aperture 850. The locking member 810 may be moved from a first open position as illustrated in FIGS. 2A and 2E, in which the onboard camera lens (and/or other components such as microphones, buttons, flashes, video lights, etc.) is generally exposed, to a second closed position as illustrated in FIGS. 2B, 2C, and 2F. In the second closed position, the lens component 820 may be mounted, inserted and/or secured to the locking member 810 and maintained in position for use with the onboard lens of the mobile electronic device as illustrated in FIGS. 2D and 2G. FIGS. 2E-2G illustrate front views of the locking member 810 in the open and closed positions and with the lens component 820 secured in position on the locking member 810, respectively when the case 800 is installed on the mobile electronic device 100.

In some embodiments, the lens component 820 may include a threaded base and the locking member 810 in conjunction with a portion of the protective case 800 may be configured to receive the threaded base (e.g., the lens component 820 may be screwed onto a threaded ring formed by the locking member 810 and portion of the protective case 800). In some embodiments, the locking member 810 in conjunction with a portion of the protective case 800 may include a bayonet mount with which the lens component 820 may be coupled.

In other embodiments as illustrated in FIGS. 2A-3C, the locking member 810 may slide or be slideable (e.g., laterally from side-to-side) relative to the protective case 800 within or through the aperture 850 of the protective case 800. The locking member 810 is slideable from the first open position (e.g., toward a first end or side of the aperture 850) to the second closed position (e.g., toward a second end or side of the aperture 850) in which the lens component 820 may be inserted and/or coupled to the protective case 800 as illustrated in FIG. 2C. For example, the locking member 810 may include a first retaining member or mounting component 814 that, in conjunction with a second retaining member or mounting component 804 of the protective case 800, form a completed mounting structure to which a lens component 820 may be mounted in the second closed position as illustrated in FIGS. 2B, 2C and 2F.

When the locking member 810 slides within the aperture 850 (e.g., formed in the protective case 800) to the second closed position in which the first mounting component 814 contacts or is positioned substantially close to the second mounting component 804, an inner locking ring 822 may be formed. The first mounting component 814 is positioned farther or substantially farther away from the second mounting component 804 in the first open position relative to the second closed position. In the closed position, the lens component 820 may be coupled to the protective case 800 by placing an outer locking ring 824 of the lens component 820 around the inner locking ring 822 formed by the curved, raised surfaces of the first and second mounting components 814, 804. In the closed position, the locking member 810 may be biased generally toward the open position, such that the first mounting component 814 is biased in a direction away (e.g., toward the first end of the aperture 850) from the second mounting component 804. As a result, the first and second mounting components 814, 804 exert outward pressure (e.g., radially outward from a center of the inner locking ring) on an inner surface of the outer locking ring 824 of the lens component 820, retaining the lens component 820 in place for use when the lens component 820 is inserted or installed onto the locking member 810 in the closed position.

The lens component 820 may include both the outer locking ring 824 and an inner ring 826 positioned radially inward of and/or concentrically within the outer locking ring 824. A ring-shaped channel (not shown) is formed or positioned between an inner surface of the outer locking ring 824 and an outer surface of the inner ring 826. In operation, the ring-shaped channel is sized and/or shaped to receive or be inserted onto the inner locking ring 822 formed by the curved, raised surfaces of the first and second mounting components 814, 804 when the lens component 820 is mounted onto the locking member 810 in the closed position. As discussed above, the first and second mounting components 814, 804 exert an outward pressure on the inner surfaces of the outer locking ring 824 that extend over the surfaces of the first and second mounting components 814, 804 as the locking component 810 is biased toward the open position from the closed position.

FIGS. 3A-3C illustrate the back of the protective case 800 illustrated in FIGS. 2A-2G with the mobile electronic device 100 removed for clarity. As seen in FIG. 3A, a spring 812 may be coupled to or integrated with the locking member 810. When the locking member 810 is in the closed position as illustrated in FIGS. 3B-3C, the spring 812 may be in contact with one or more touch points 834 of the protective case 800 and/or other portion of the locking member 810 (e.g., surface). Due to the nature of the spring 812 and the location of the touch points 834, the spring 812 may be urged away from the touch points 834, thereby biasing the locking member 810 and first mounting component 814 away from the second mounting component 804 towards the first open position. The spring loaded or biased locking member 810 biases the first mounting component 814 against outer locking ring of the locking member 810 to maintain or secure the lens component 820 in place.

In some embodiments, the locking member 810 can include a grip portion 828. The grip portion 820 may include a curvature or outer perimeter shaped to correspond to an outline or curvature of a finger (e.g., thumb, index finger, etc).

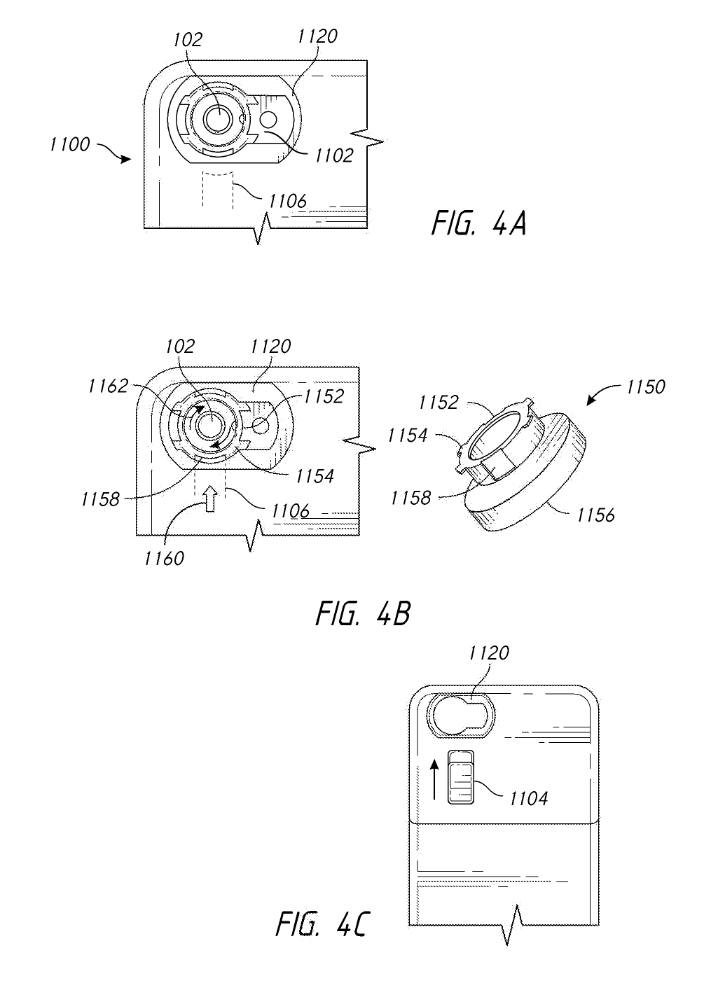

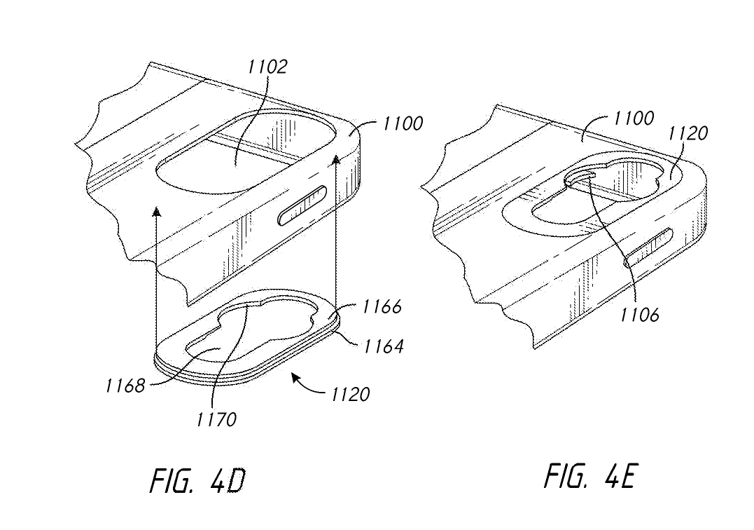

FIGS. 4A-4C illustrates a protective case 1100 for a mobile electronic device. The protective case 1100 may have an aperture 1102 through which an onboard camera lens 102 of a mobile electronic device may be accessed. A lens component 1150 may be coupled to the protective case 1100 for use with the mobile electronic device. In some embodiments, the lens component 1150 may be coupled to a removable insert 1120 (e.g., shim, tapered member, wedge member) that is installed or mounted in and/or around the aperture 1102.

FIGS. 4D-4E illustrate the installation of the insert 1120 into the aperture 1102 of the protective case 1100 and the insert 1120 mounted or installed on the protective case 1100. The insert 1120 may be replaceable with other inserts 1120 that alter the tilt of the lens with respect to the mobile electronic device. Such tilt can be added to override, correct for, or compensate for intentional or unintentional tilt of the onboard camera lens 102 (e.g., due to manufacturing variances), or to add tilt to the lens component 1150 with respect to the onboard camera lens 102. The angle or tilt of different shims for use with the lens components can vary. In some embodiments, a protective case 1100 may include a permanent or semi-permanent mounting structure instead of using inserts 1120.

In some embodiments, the insert 1120 includes a stacked, layered and/or stepped configuration. For example, the insert 1120 can include a first base portion 1164 and a second portion 1166 stacked above or layered on top of the first base portion 1164. The outer perimeter or shape of the portions 1164, 1166 can be the same or different from one another. In some embodiments, both portions 1164, 1166 are shaped generally corresponding to the shape of the aperture 1102. The base portion 1164 may have a larger or increased outer perimeter relative to the second portion 1166 forming a lip or ridge member below the second portion 1166. As illustrated in FIGS. 4D-4E, when the insert 1120 is inserted into position within the aperture 1102, the lip member is configured to engage with an inner surface of the protective case 1100 and/or aperture 1102. These surfaces can be secured together with adhesive or by some other mechanism (e.g., friction fit, snap-fit, pins, bolts, interference fit). Once the insert 1120 is installed, a top or outer surface of the second portion 1166 is generally flush with the outer or top surface of the aperture 1102 and/or protective case 1100.

As illustrated and discussed above, different inserts 1120 can have different tilt angles. The inserts 1120 can have different configurations. For example, the inserts can have different shaped layers stacked on each other. The inserts can have different or various shaped apertures. The inserts can have various numbers of layers. Different stacked configurations and angled layers can determine the tilt angle, etc.

The insert 1120 may include an aperture 1168 configured to receive the removable lens component 1150. The aperture 1168 may be shaped with one or more portions or edges 1170 configured to receive portions of the locking base 1152 (e.g., locking structures 1152) as discussed below. The aperture 1168 can be variously-shaped (e.g., circular, oval, diamond, triangular, polygonal, cross-shaped) with one or more round and/or sharp edges 1170. Different shaped and sized inserts can also allow the mobile electronic device and/or insert to receive and mount different types of lenses and other accessories (e.g., tripods, flashes, etc.)

The lens component 1150 may include a locking base 1152 with one or more locking structures 1154 (e.g., tabs, protrusions) and one or more channels or recesses 1158. The base 1152 may be placed or received in the insert 1120 (e.g., within the aperture 1168). The locking structures 1154 may be rotated (e.g., by rotating the lens component 1150 in direction indicated by arrows 1162) such that one or more locking structures 1154 are positioned behind a portion of the insert 1120 (e.g., a portion of the edges 1170 of the aperture 1168 is between a locking structure 1154 and the lens housing 1156 of the lens component 1150) to prevent removal of the lens component 1150. A locking switch 1104 (e.g., handle, sliding button, lever, and/or dial, etc.) of the protective case 1100 may be moved from a first open position (e.g., unlocked, unsecured, disengaged, installing) to a second closed position (e.g., locked, engaged, secured). In response to the switch 1104 moved to the closed position in a direction as indicted by arrow 1160 (e.g., vertically upward, or laterally as illustrated in FIG. 4E, etc.) a pin 1106 or other slidable engagement member may be moved toward the base 1152 of the lens component 1150 (e.g., and into engagement with one or more recesses 1158) such that the pin 1106 prevents rotation of the lens component 1150 by preventing or inhibiting movement of the locking structures 1154 and securing the lens component 1150 in position. In some embodiments, the pin 1106 is moved into engagement with one of the one or more recesses or channels 1158 formed in the base 1152. When the locking switch 1104 is opened or moved toward the open position (e.g., moved vertically downward, toward the opposite end or side as in the closed position, etc.) the pin 1106 may be retracted or disengaged from the base 1152 of the lens component 1150, thereby allowing rotation and removal of the lens component 1150. In some embodiments, the pin 1106 is disengaged from one of the one or more channels or recesses 1158 of the base 1152 in the open position. The lens component 1150 may be held in position relative to the protective case 1100 by additional locking structures or mechanisms, friction, and the like.

Although these inventions have been disclosed in the context of a certain preferred embodiments and examples, it will be understood by those skilled in the art that the present inventions extend beyond the specifically disclosed embodiments to other alternative embodiments and/or uses of the inventions and obvious modifications and equivalents thereof. It is also contemplated that various combinations or subcombinations of the specific features and aspects of the embodiments may be made and still fall within the scope of these inventions. Accordingly, it should be understood that various features and aspects of the disclosed embodiments can be combine with or substituted for one another in order to form varying modes of the disclosed inventions. Thus, it is intended that the scope of at least some of the present inventions herein disclosed should not be limited by the particular disclosed embodiments described above.

What is claimed is:

1. A mounting component for mounting a removable lens component and configured to be removably attachable to a mobile electronic device, the mounting component comprising:
an aperture configured to generally expose an on-board lens of a mobile electronic device when the mounting component is installed on the mobile electronic device, wherein the aperture is configured to receive a removable lens component;
an engagement member configured to engage with a corresponding engagement structure of the removable lens component to secure the removable lens component in position on the mobile electronic device;
wherein at least one of the engagement member and engagement structure is movable between a first position and a second position, wherein in the first position the engagement member and engagement structure are configured to be in engagement with one another and in the second position, the engagement member and engagement structure are space apart relative to one another.

2. The mounting component of claim 1, comprising a protective case for a mobile electronic device.

3. The mounting component of claim 1, wherein the engagement member is slidable within the aperture between the first position and the second position.

4. The mounting component of claim 3, wherein the engagement member comprises a curved surface forming an inner locking ring with a curved engagement member of the protective case in the first position, wherein the inner locking ring is configured to receive an outer locking ring of the engagement structure of a removable lens component in the first position.

5. The mounting component of claim 4, wherein the curved surface of the inner locking ring is biased towards the second position and exerts an outward force on an inner surface of the outer locking ring of the engagement structure of a removable lens component to secure the removable lens component in position on the mobile electronic device when the outer locking ring is received by the inner locking ring.

6. The mounting component of claim 1, comprising at least one of a body member configured to be attachable to a first corner of a mobile electronic device and a protective case for a mobile electronic device.

7. The mounting component of claim 6, wherein the engagement member comprises a recess configured to receive the engagement structure of a removable lens component in the first position to secure a removable lens component in position on the mobile electronic device.

8. The mounting component of claim 7, wherein a removable lens component comprises an actuatable handle for moving the engagement structure between the first position and the second position.

9. The mounting component of claim 2, further comprising an insert configured to be installed in the aperture.

10. The mounting component of claim 9, wherein the insert is configured to receive a removable lens component within an aperture formed on the insert.

11. The mounting component of claim 10, wherein first and second inserts can be installed in the aperture and wherein the first insert is configured to mount a removable lens component at a first angle relative to the mobile electronic device and the second insert is configured to mount a removable lens component at a second angle relative to the mobile electronic device, the first angle different from the second angle.

12. The mounting component of claim 10, wherein a removable lens component received in the insert is rotatable within the aperture of the insert such that a first engagement structure of the removable lens component is positioned under an edge portion of the insert.

13. The mounting component of claim 12, wherein the engagement member is slidable between the first position for engaging with a second engagement structure of a removable lens component to prevent rotation of the removable lens component and the second position for disengaging from the second engagement structure of the removable lens component to allow rotation of the removable lens component within the insert.

14. The mounting component of claim 13, wherein the insert comprises a first and second layer, the first layer configured to be engaged with an inner surface of the protective case and the second layer configured to be generally flush with an outer surface of the protective case when the insert is installed within the aperture.

15. A removable lens component configured to be removably attachable to a mobile electronic device, the removable lens component comprising:
a first aperture configured to be in optical communication with an on-board lens of a mobile electronic device when the removable lens component is installed on the mobile electronic device;
an engagement member configured to engage with a corresponding engagement structure of at least one of a protective case and a mounting component installed on the mobile electronic device to secure the removable lens component in position on the mobile electronic device;
wherein at least one of the engagement member and engagement structure is movable between a first position and a second position, wherein in the first position the engagement member and engagement structure are configured to be in engagement with one another and in the second position, the engagement member and engagement structure are space apart relative to one another.

16. The removable lens component of claim 15, wherein the engagement member is coupled to an actuator such that moving the actuator between the first and second positions, moves the engagement member in and out of engagement with the engagement structure.

17. The removable lens component of claim 16, wherein the actuator comprises one of a handle and lever movable by a user.

18. The removable lens component of claim 15, wherein the removable lens component is configured to be positioned within a second aperture of an insert on the protective case and is rotatable within the second aperture such the engagement member is positionable under a surface of the insert.

19. The removable lens component of claim 18, wherein the removable lens comprises a second engagement member configured to receive an engagement structure of the protective case in the first position such that the removable lens is prevented from rotating within the second aperture.

20. The removable lens component of claim 15, wherein the engagement member comprises an outer locking ring configured to be received by an inner ring formed by first and second engagement structures of the protective case.
